(19) United States
(12) Patent Application Publication
(10) Pub. No.: US 2021/0284846 A1
(43) Pub. Date: Sep. 16, 2021

(54) PIGMENT COMPOSITE PARTICLE

(71) Applicant: INDUSTRIAL TECHNOLOGY RESEARCH INSTITUTE, Hsinchu (TW)

(72) Inventors: Cheng En WU, New Taipei City (TW); Li Wen CHEN, Taichung City (TW); Chih Lung CHIU, Kaohsiung City (TW); Pang-Hung LIU, Hsinchu City (TW)

(73) Assignee: INDUSTRIAL TECHNOLOGY RESEARCH INSTITUTE, Hsinchu (TW)

(21) Appl. No.: 16/820,237

(22) Filed: Mar. 16, 2020

(51) Int. Cl. C09B 29/08; C09B 67/08; C09B 67/02

(52) U.S. Cl. CPC C09B 29/083; C09D 17/003; C09B 67/0097; C09B 67/0013

(57) ABSTRACT

A pigment composite particle is provided, which includes an organic pigment core, a polyelectrolyte shell wrapped around the organic pigment core, and an oxide shell wrapped around the polyelectrolyte shell. The organic pigment core is water-insoluble. The organic pigment core and the polyelectrolyte shell have a weight ratio of 1:0.25 to 1:1. The oxide shell is formed from tetraalkyl orthosilicate, tetraalkyl orthotitanate, or a combination thereof, and the organic pigment core and the tetraalkyl orthosilicate, tetraalkyl orthotitanate, or the combination thereof have a weight ratio of 1:0.7 to 1:3.

### TECHNICAL FIELD

The technical field relates to pigment composite particle, especially relates to organic pigment composite particle

### BACKGROUND

Paint used on the exteriors of buildings requires excellent climate resistance, and inorganic pigments are good at the climate resistance. Therefore, the inorganic pigments are used most commonly. Conversely, organic pigments are less common. However, as the awareness of the need for environmental protection rises, countries around the world have begun to list some inorganic pigments as prohibited or highly concerned substances. For example, chrome yellow is a yellow pigment that was very popular because of its low cost, good climate resistance, and bright colors. However, chrome yellow contains chromium, so long-term use possesses a carcinogenic risk to the human body. Therefore, the European Chemical Agency pays close attention to this substance and may ban it at any time in the future. Since some inorganic pigments have a high risk of being banned, a climate resistant pigment is called for to replace these inorganic pigments.

### SUMMARY

One embodiment of the disclosure provides a pigment composite particle, including an organic pigment core, a polyelectrolyte shell wrapped around the organic pigment core, and an oxide shell wrapped around the polyelectrolyte shell. The organic pigment core is water-insoluble.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a pigment composite particle in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

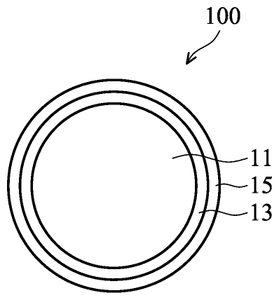

As shown in FIG. 1, one embodiment of the disclosure provides a pigment composite particle 100, including an organic pigment core 11 that is water-insoluble, a polyelectrolyte shell 13 wrapped around the organic pigment core 11, and an oxide shell 15 wrapped around the polyelectrolyte shell 13. Although the organic pigment core 11 and the corresponding pigment composite particle 100 in FIG. 1 are ball-shaped, they can be oval, polygon, or another suitable shape.

In some embodiments, the organic pigment core 11 has a chemical structure of

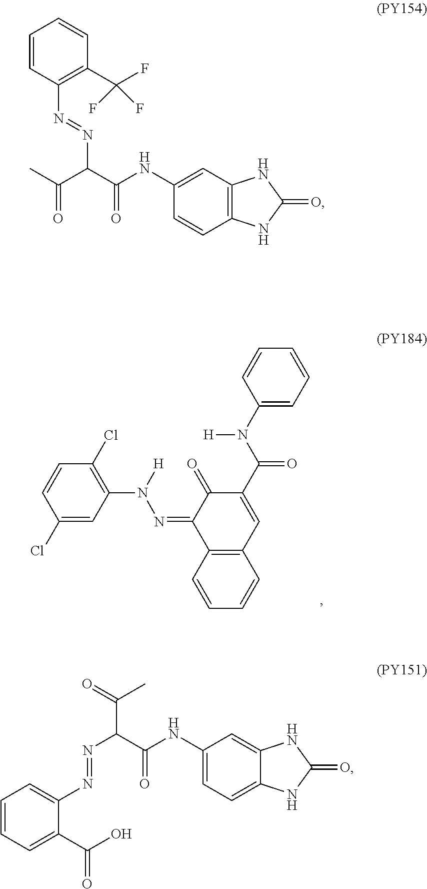 [SMILES: CC(=O)C(/N=N/c1ccccc1C(F)(F)F)C(=O)Nc1ccc2[nH]c(=O)[nH]c2c1 ; O=C(Nc1ccccc1)C1=Cc2ccccc2/C(=N/Nc2cc(Cl)ccc2Cl)C1=O ; CC(=O)C(/N=N/c1ccccc1C(=O)O)C(=O)Nc1ccc2[nH]c(=O)[nH]c2c1]

and the like, or a combination thereof. PY154, PY184, and PY151 are commercially available from CINIC. Note that the organic pigment core 11 is insoluble in water. If the organic pigment is soluble in water, it cannot provide core-shell structure, so inorganic substances cannot be evenly coated on the outer layer of the pigment structure. In some embodiments, the organic pigment core has a diameter of 200 nm to 5 μm. If the diameter of the organic pigment core 11 is too small, it will cause excessive cost during grinding. If the diameter of the organic pigment core 11 is too large, organic pigments cannot be well protected, resulting in poor weather resistance.

In some embodiments, the polyelectrolyte shell 13 is negatively charged. For example, the polyelectrolyte shell 13 includes polystyrene sulfonate, poly(acrylic acid), or a combination thereof.

Alternatively, the polyelectrolyte shell 13 is positively charged. For example, the polyelectrolyte shell 13 includes poly(diallyldimethylammonium chloride), p-aminohippurate, polyacrylamide, or a combination thereof.

Note that the polyelectrolyte shell 13 is composed of a single layer of positively charged polyelectrolyte or a single layer of negatively charged polyelectrolyte, rather than an alternate stack of the positively charged polyelectrolyte layer and the negatively charged polyelectrolyte layer. As proven in experiments of the disclosure, the single layered polyelectrolyte layer of positive charge or negative charge results in a better climate resistance than the alternate stack of the polyelectrolyte layer of the opposite charges.

In some embodiments, the polyelectrolyte shell 13 has a weight average molecular weight of 70,000 to 350,000. If the weight average molecular weight of the polyelectrolyte shell 13 is too low, it will cause insufficient chargeability of the pigment periphery, making the outer inorganic layer cannot be uniformly coated. If the weight average molecular weight of the polyelectrolyte shell 13 is too high, it will cause the particle size of the composite pigment to be too large, and will cause excessive extra costs.

In some embodiments, the organic pigment core 11 and the polyelectrolyte shell 13 have a weight ratio of 1:0.25 to 1:1. If the ratio of the polyelectrolyte shell is too low, it will cause insufficient chargeability of the pigment periphery, such that the outer inorganic layer cannot be uniformly coated. If the ratio of the polyelectrolyte shell is too high, it will cause the particle size of the composite pigment to be too large, and will cause excessive extra costs.

In some embodiments, the oxide shell 15 is formed from tetraalkyl orthosilicate (such as tetramethyl orthosilicate, tetraethyl orthosilicate (TEOS), tetrapropyl orthosilicate, and the like, or a combination thereof), tetraalkyl orthotitanate (such as tetrabutyl orthotitanate (TBOT), and the like, or a combination thereof), or a combination thereof. In some embodiments, the organic pigment core 11 and the tetraalkyl orthosilicate, tetraalkyl orthotitanate, or the combination thereof have a weight ratio of 1:0.7 to 1:3. If the ratio of the tetraalkyl orthosilicate, tetraalkyl orthotitanate, or a combination thereof is too low, the coating thickness of the inorganic layer is too thin, which will cause the weather resistance of the composite pigment to not be improved. If the ratio of the tetraalkyl orthosilicate, tetraalkyl orthotitanate, or a combination thereof is too high, the coating thickness of the inorganic layer is too thick, which will cause obvious color shift of the composite pigment.

In some embodiments, the pigment composite particle 100 has a diameter of 300 nm to 10 μm. If the pigment composite particle 100 is too small, it will make it difficult to maintain stable dispersion and cause excessive extra costs. If the pigment composite particle 100 is too large, it will make the particles difficult to disperse, and the subsequent coating film is more likely to have a grainy feeling.

In some embodiments, the water insoluble organic pigment and polyelectrolyte can be ball-milled to form the polyelectrolyte shell 13 wrapped around the organic pigment core 11. The core-shell structure can be dispersed, and the tetraalkyl orthosilicate, tetraalkyl orthotitanate, or a combination thereof can be added to the dispersion to perform a sol-gel reaction, thereby forming an oxide shell 15 wrapped around the polyelectrolyte shell 13. On the other hand, one skilled in the art may form the oxide shell 15 by any suitable process, which is not limited to the sol-gel reaction.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

First, 10 g of organic pigment powder PY154, 100 g of de-ionized water, and 20 g of zirconia beads (diameter of 1 mm) were added into a ball miller to mill for 1 hour to 2 hours. 2.5 g of positively charged polyelectrolyte poly(diallyldimethylammonium chloride) (PDADMAC, MW=200,000˜350,000 commercially available from Sigma-Aldrich) and 30 mL of 1M NaCl solution (serving as buffer liquid to prevent PDADMAC from being adsorbed too fast, which could result in non-uniform charge distribution on the surface of the organic pigment powder) were then added into the ball miller to mill for 1 hour to 2 hours, until the organic pigment powder was wrapped by a PDADMAC shell, and positive charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with positive charges.

The positively charged organic pigment powder was added to ethanol to prepare dispersion with a solid content of 20%. 10 g of water, 50 g of ethanol, 1 g of polyvinylpyrrolidone (PVP), and 0.1 g to 0.3 g of 25% ammonia were added into the dispersion and stirred at room temperature for 1 hour, such that the pH value of the dispersion was adjusted to about 8 to 10. Subsequently, 7 g of tetraethyl orthosilicate (TEOS) was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Example 2

First, 10 g of organic pigment powder PY154, 100 g of de-ionized water, and 20 g of zirconia beads (diameter of 1 mm) were added into a ball miller to mill for 1 hour to 2 hours. 5 g of positively charged polyelectrolyte PDADMAC (MW=200,000˜350,000 commercially available from Sigma-Aldrich) and 30 mL of 1M NaCl solution (serving as buffer liquid to prevent PDADMAC from being adsorbed too fast, which could result in non-uniform charge distribution on the surface of the organic pigment powder) were then added into the ball miller to mill for 1 hour to 2 hours, until the organic pigment powder was wrapped by a PDADMAC shell, and positive charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with positive charges.

The positively charged organic pigment powder was added to ethanol to prepare dispersion with a solid content of 20%. 10 g of water, 50 g of ethanol, 1 g of PVP, and 0.1 g to 0.3 g of 25% ammonia were added into the dispersion and stirred at room temperature for 1 hour, such that the pH value of the dispersion was adjusted to about 8 to 10. Subsequently, 21 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Example 3

First, 10 g of organic pigment powder PY154, 100 g of de-ionized water, and 20 g of zirconia beads (diameter of 1 mm) were added into a ball miller to mill for 1 hour to 2 hours. 2.5 g of positively charged polyelectrolyte PDADMAC (MW=200,000˜350,000 commercially available from Sigma-Aldrich) and 30 mL of 1M NaCl solution (serving as buffer liquid to prevent PDADMAC from being adsorbed too fast, which could result in non-uniform charge distribution on the surface of the organic pigment powder) were then added into the ball miller to mill for 1 hour to 2 hours, until the organic pigment powder was wrapped by a PDADMAC shell, and positive charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with positive charges.

The positively charged organic pigment powder was added to ethanol to prepare dispersion with a solid content of 20%. 10 g of water, 50 g of ethanol, 1 g of PVP, and 0.1 g to 0.3 g of 25% ammonia were added into the dispersion and stirred at room temperature for 1 hour, such that the pH value of the dispersion was adjusted to about 8 to 10. Subsequently, 1.1 g of tetrabutyl orthotitanate (TBOT) was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Example 4

First, 10 g of organic pigment powder PY154, 100 g of de-ionized water, and 20 g of zirconia beads (diameter of 1 mm) were added into a ball miller to mill for 1 hour to 2 hours. 2.5 g of negatively charged polyelectrolyte polystyrene sulfonate (PSS, MW=70,000 commercially available from Sigma-Aldrich) was then added into the ball miller to mill for 1 hour to 2 hours, until the organic pigment powder was wrapped by a PSS shell, and negative charges were uniformly distributed on the organic pigment powder surface. The zirconia beads were removed, and the particles were washed with de-ionized water for 1 to 3 times, and the particles then collected by centrifuge and dried to obtain organic pigment powder (wrapped by the polyelectrolyte shell) with negative charges.

The negatively charged organic pigment powder was added to ethanol to prepare dispersion with a solid content of 20%. 10 g of water, 50 g of ethanol, 1 g of PVP, and 2 g of 0.1N to 1N HCl were added into the dispersion and stirred at room temperature for 1 hour, such that the pH value of the dispersion was adjusted to about 4 to 6. Subsequently, 7 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Example 5

First, 10 g of organic pigment powder PY154, 100 g of de-ionized water, and 20 g of zirconia beads (diameter of 1 mm) were added into a ball miller to mill for 1 hour to 2 hours. 5 g of negatively charged polyelectrolyte PSS (MW=70,000 commercially available from Sigma-Aldrich) was then added into the ball miller to mill for 1 hour to 2 hours, until the organic pigment powder was wrapped by a PSS shell, and negative charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with negative charges.

The negatively charged organic pigment powder was added to ethanol to prepare dispersion with a solid content of 20%. 10 g of water, 50 g of ethanol, 1 g of PVP, and 2 g of 0.1N to 1N HCl were added into the dispersion and stirred at room temperature for 1 hour, such that the pH value of the dispersion was adjusted to about 4 to 6. Subsequently, 21 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Comparative Example 1

The organic pigment powder PY154 was exposed to UV-B to measure its climate resistance. The exposure period of 200 hours is similar to outdoor use for a period of 1 year, and so on.

### Comparative Example 2

First, 10 g of organic pigment powder PY154, 100 g of de-ionized water, and 20 g of zirconia beads (diameter of 1 mm) were added into a ball miller to mill for 1 hour to 2 hours. The zirconia beads were removed, and the particles were washed with de-ionized water 1 to 3 times, then collected by centrifuge, and dried to obtain organic pigment powder. The organic pigment powder was added to ethanol to prepare dispersion with a solid content of 20%. 10 g of water, 50 g of ethanol, 1 g of PVP, and 2 g of 0.1N to 1N HCl were added into the dispersion and stirred at room temperature for 1 hour, such that the pH value of the dispersion was adjusted to about 4 to 6. Subsequently, 7 g of TEOS was added into the dispersion to perform a sol-gel reaction at a temperature of 50° C. to 80° C. for a period of 3 to 6 hours, thereby forming an oxide shell wrapped around the organic pigment powder. After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Comparative Example 3

First, 10 g of organic pigment powder PY154, 100 g of de-ionized water, and 20 g of zirconia beads (diameter of 1 mm) were added into a ball miller to mill for 1 hour to 2 hours. The zirconia beads were removed, and the particles were washed with de-ionized water for 1 to 3 times, and the particles were then collected by centrifuge and dried to obtain organic pigment powder. The organic pigment powder was added to ethanol to prepare dispersion with a solid content of 20%. 10 g of water, 50 g of ethanol, 1 g of PVP, and 2 g of 0.1N to 1N HCl were added into the dispersion and stirred at room temperature for 1 hour, such that the pH value of the dispersion was adjusted to about 4 to 6. Subsequently, 21 g of TEOS was added into the dispersion to perform a sol-gel reaction at a temperature of 50° C. to 80° C. for a period of 3 to 6 hours, thereby forming an oxide shell wrapped around the organic pigment powder. After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

TABLE 1

| | Organic | | | | | | Climate | Climate | Climate |
|---|---|---|---|---|---|---|---|---|---|
| | pigment | Polyelectrolyte (g) | | | | Stabilizer | resistance | resistance | resistance |
| | PY154 | (+) | (−) | TEOS | TBOT | (g) | 500 hrs | 1000 hrs | 2000 hrs |
| | (g) | PDADMAC | PSS | (g) | (g) | PVP | (ΔE) | (ΔE) | (ΔE) |
| Example 1 | 10 | 2.5 | 0 | 7 | 0 | 1 | 1.50 | 1.79 | 2.15 |
| Example 2 | 10 | 5 | 0 | 21 | 0 | 1 | 1.38 | 1.60 | 1.91 |
| Example 3 | 10 | 2.5 | 0 | 0 | 1.1 | 1 | 0.35 | 1.29 | |
| Example 4 | 10 | 0 | 2.5 | 7 | 0 | 1 | 0.63 | 0.84 | |
| Example 5 | 10 | 0 | 5 | 21 | 0 | 1 | 0.43 | 0.58 | |
| Comparative | 10 | 0 | 0 | 0 | 0 | 0 | 1.98 | 12.9 | |
| Example 1 | | | | | | | | | |
| Comparative | 10 | 0 | 0 | 7 | 0 | 1 | 1.44 | 2.82 | 6.36 |
| Example 2 | | | | | | | | | |
| Comparative | 10 | 0 | 0 | 21 | 0 | 1 | 1.48 | 2.25 | 4.61 |
| Example 3 | | | | | | | | | |

### Example 6

First, 10 g of organic pigment powder mixture (PY154 and PY184), 100 g of de-ionized water, and 20 g of zirconia beads (diameter of 1 mm) were added into a ball miller to mill for 1 hour to 2 hours. 2.5 g of positively charged polyelectrolyte PDADMAC (MW=200,000˜350,000 commercially available from Sigma-Aldrich) and 30 mL of 1M NaCl solution (serving as buffer liquid to prevent PDADMAC from being adsorbed too fast, which could result in non-uniform charge distribution on the surface of the organic pigment powder) were then added into the ball miller to mill for 1 hour to 2 hours, until the organic pigment powder was wrapped by a PDADMAC shell, and positive charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with positive charges.

The positively charged organic pigment powder was added to ethanol to prepare dispersion with a solid content of 20%. 10 g of water, 50 g of ethanol, 1 g of PVP, and 0.1 g to 0.3 g of 25% ammonia were added into the dispersion and stirred at room temperature for 1 hour, such that the pH value of the dispersion was adjusted to about 8 to 10. Subsequently, 7 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Example 7

First, 10 g of organic pigment powder mixture (PY154 and PY184), 100 g of de-ionized water, and 20 g of zirconia beads (diameter of 1 mm) were added into a ball miller to mill for 1 hour to 2 hours. 5 g of positively charged polyelectrolyte PDADMAC (MW=200,000˜350,000 commercially available from Sigma-Aldrich) and 30 mL of 1M NaCl solution (serving as buffer liquid to prevent PDADMAC from being adsorbed too fast, which could result in non-uniform charge distribution on the surface of the organic pigment powder) were then added into the ball miller to mill for 1 hour to 2 hours, until the organic pigment powder was wrapped by a PDADMAC shell, and positive charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with positive charges.

The positively charged organic pigment powder was added to ethanol to prepare dispersion with a solid content of 20%. 10 g of water, 50 g of ethanol, 1 g of PVP, and 0.1 g to 0.3 g of 25% ammonia were added into the dispersion and stirred at room temperature for 1 hour, such that the pH value of the dispersion was adjusted to about 8 to 10. Subsequently, 21 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Comparative Example 4

The organic pigment mixture powder (PY154 & PY184) was exposed to UV-B to measure its climate resistance. The exposure period of 200 hours is similar to outdoor use for a period of 1 year, and so on.

TABLE 2

| | Organic | | | | | | Climate |
|---|---|---|---|---|---|---|---|
| | pigment | Polyelectrolyte (g) | | | | Stabilizer | resistance |
| | (g) PY154 | (+) | (−) | TEOS | TBOT | (g) | 1000 hrs |
| | & PY 184 | PDADMAC | PSS | (g) | (g) | PVP | (ΔE) |
| Example 6 | 10 | 2.5 | 0 | 7 | 0 | 1 | 0.59 |
| Example 7 | 10 | 5 | 0 | 21 | 0 | 1 | 0.47 |
| Comparative | 10 | 0 | 0 | 0 | 0 | 1 | 5.48 |
| Example 4 | | | | | | | |

### Example 8

First, 10 g of organic pigment powder PY154, 100 g of de-ionized water, and 20 g of zirconia beads (diameter of 1 mm) were added into a ball miller to mill for 1 hour to 2 hours. 1.25 g of negatively charged polyelectrolyte PSS (70,000 commercially available from Sigma-Aldrich) and 1.25 g of negatively charged polyelectrolyte poly(acrylic acid) (PAA, MW=100,000 commercially available from Sigma-Aldrich) were then added into the ball miller to mill for 1 hour to 2 hours, until the organic pigment powder was wrapped by a PSS and PAA shell, and negative charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with negative charges.

The negatively charged organic pigment powder was added to ethanol to prepare dispersion with a solid content of 20%. 10 g of water, 50 g of ethanol, 1 g of PVP, and 2 g of 0.1N to 1N HCl were added into the dispersion and stirred at room temperature for 1 hour, such that the pH value of the dispersion was adjusted to about 4 to 6. Subsequently, 7 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Comparative Example 5

First, 10 g of organic pigment powder PY154, 100 g of de-ionized water, and 20 g of zirconia beads (diameter=1 mm) were added into a ball miller to mill for 1 hour to 2 hours. 10 g of negatively charged polyelectrolyte PSS (70,000 commercially available from Sigma-Aldrich) was then added into the ball miller to mill for 1 hour to 2 hours, until the organic pigment powder was wrapped by a PSS shell, and negative charges were uniformly distributed on the organic pigment powder surface. The zirconia beads were removed, and the particles were washed with de-ionized water for 1 to 3 times, and the particles were then collected by centrifuge, and dried to obtain organic pigment powder (wrapped by the polyelectrolyte shell) with negative charges.

1.5 g of positively charged polyelectrolyte PDADMAC (MW=200,000˜350,000 commercially available from Sigma-Aldrich) and 30 mL of 1M NaCl solution (serving as buffer liquid to prevent PDADMAC from being adsorbed too fast, which could result in non-uniform charges on the surface of the organic pigment powder) were then added into the ball miller to mill for 1 hour to 2 hours, until the PSS shell was wrapped by a PDADMAC shell, and positive charges were uniformly distributed on the organic pigment powder surface. The zirconium balls were removed, and the particles were washed by de-ionized water for 1 to 3 times, and the particles were then collected by centrifuge and dried to obtain organic pigment powder (wrapped by the double polyelectrolyte shell of PSS and PDADMAC) with positive charges.

The positively charged organic pigment powder was added to ethanol to prepare dispersion with a solid content of 20%. 10 g of water, 50 g of ethanol, 1 g of polyvinylpyrrolidone (PVP), and 0.1 g to 0.3 g of 25% ammonia were added into the dispersion and stirred at room temperature for 1 hour, such that the pH value of the dispersion was adjusted to about 8 to 10. Subsequently, 24 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Comparative Example 6

First, 10 g of organic pigment powder PY154, 100 g of de-ionized water, and 20 g of zirconia beads (diameter of 1 mm) were added into a ball miller to mill for 1 hour to 2 hours. 30 g of negatively charged polyelectrolyte PSS (70,000 commercially available from Sigma-Aldrich) was then added into the ball miller to mill for 1 hour to 2 hours, until the organic pigment powder was wrapped by a PSS shell, and negative charges were uniformly distributed on the organic pigment powder surface. The zirconia beads were removed, and the particles were washed with de-ionized water for 1 to 3 times, and the particles were then collected by centrifuge and dried to obtain organic pigment powder (wrapped by the polyelectrolyte shell) with negative charges.

30 g of positively charged polyelectrolyte PDADMAC (MW=200,000˜350,000 commercially available from Sigma-Aldrich) and 30 mL of 1M NaCl solution (serving as buffer liquid to prevent PDADMAC from being adsorbed too fast, which could result in non-uniform charge distribution on the surface of the organic pigment powder) were then added into the ball miller to mill for 1 hour to 2 hours, until the PSS shell was wrapped by a PDADMAC shell, and positive charges were uniformly distributed on the organic pigment powder surface. The zirconium balls were removed, and the particles were washed by de-ionized water 1 to 3 times, then collected by centrifuge, and dried to obtain organic pigment powder (wrapped by the double polyelectrolyte shell of PSS and PDADMAC) with positive charges.

The positively charged organic pigment powder was added to ethanol to prepare dispersion with a solid content of 20%. 10 g of water, 50 g of ethanol, 1 g of polyvinylpyrrolidone (PVP), and 0.1 g to 0.3 g of 25% ammonia were added into the dispersion and stirred at room temperature for 1 hour, such that the pH value of the dispersion was adjusted to about 8 to 10. Subsequently, 40 g of TEOS was added into the dispersion to perform a sol-gel reaction at a temperature of 50° C. to 80° C. for a period of 3 to 6 hours, thereby forming an oxide shell wrapped around the polyelectrolyte shell (and the organic pigment powder was wrapped by the polyelectrolyte shell as described above). After completing the sol-gel reaction, the organic-inorganic composite pigment powder was collected by centrifuge, dried, and then exposed to UV-B to measure its climate resistance. The exposure period of 200 hours is similar to outdoor use for a period of 1 year, and so on.

### Comparative Example 7

Commercially available inorganic powder Bismuth yellow (Bismuth yellow commercially available from Habich) was exposed to UV-B to measure its climate resistance. The exposure period of 200 hours is similar to outdoor use for a period of 1 year, and so on.

TABLE 3

| | Organic | | | | | Climate | Climate | Climate |
|---|---|---|---|---|---|---|---|---|
| | pigment | Polyelectrolyte (g) | | | Stabilizer | resistance | resistance | resistance |
| | (g) | (+) | (−) | TEOS | (g) | 500 hrs | 1000 hrs | 2000 hrs |
| | PY154 | PDADMAC | PSS/PAA | (g) | (PVP) | (ΔE) | (ΔE) | (ΔE) |
| Example 1 | 10 | 2.5 | 0/0 | 7 | 1 | 1.50 | 1.79 | 2.15 |
| Example 2 | 10 | 5 | 0/0 | 21 | 1 | 1.38 | 1.60 | 1.91 |
| Example 3 | 10 | 2.5 | 0/0 | 0 | 1 | 0.35 | 1.29 | |
| Example 4 | 10 | 0 | 2.5/0 | 7 | 1 | 0.63 | 0.84 | |
| Example 5 | 10 | 0 | 5/0 | 21 | 1 | 0.43 | 0.58 | |
| Comparative | 10 | 1.5 | 10/0 | 24 | 1 | 1.75 | 3.70 | 3.75 |
| Example 5 | | | | | | | | |
| Comparative | 10 | 30 | 30/0 | 40 | 1 | 1.23 | 2.29 | 4.70 |
| Example 6 | | | | | | | | |

TABLE 4

| | Organic | | | | | | | |
|---|---|---|---|---|---|---|---|---|
| | pigment | | | | | Climate | Climate | Climate |
| | (g) | Polyelectrolyte (g) | | | Stabilizer | resistance | resistance | resistance |
| | Bismuth | (+) | (−) | TEOS | (g) | 500 hrs | 1000 hrs | 2000 hrs |
| | yellow | PDADMAC | PSS/PAA | (g) | (PVP) | (ΔE) | (ΔE) | (ΔE) |
| Comparative | 10 | 0 | 0 | 0 | 0 | 2.18 | 3.69 | 8.08 |
| Example 7 | | | | | | | | |

As shown in Table 3, the water insoluble organic pigment was wrapped by a single layered polyelectrolyte, and the silicon oxide or titanium oxide layer was then formed on the polyelectrolyte layer, which could efficiently improve the climate resistance of the composite pigment. Note that if the organic pigment was wrapped by alternately stacked polyelectrolyte layers of opposite charges, and the silicon oxide or titanium oxide layer was then formed on the stack of the polyelectrolyte layers, the composite pigment would be degraded (compared to the single layered polyelectrolyte layer).

Besides, as shown in Table 3 and 4, the water insoluble organic pigment PY154 was wrapped by a single layered polyelectrolyte, and the silicon oxide or titanium oxide layer was then formed on the polyelectrolyte layer, which could efficiently improve the climate resistance of the composite pigment as compared with Comparative Example 7. In Comparative Example 7 the organic pigment core is made of Bismuth yellow.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A pigment composite particle, comprising:
an organic pigment core;
a polyelectrolyte shell wrapped around the organic pigment core; and
an oxide shell wrapped around the polyelectrolyte shell,
wherein the organic pigment core is water-insoluble.

2. The pigment composite particle as claimed in claim 1, wherein the organic pigment core has a chemical structure of 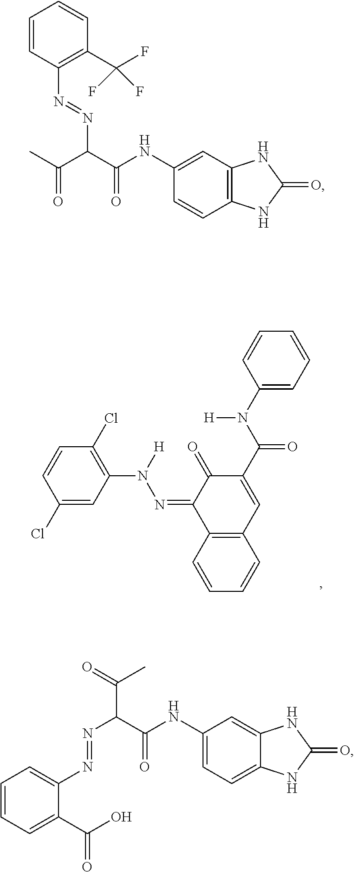 [SMILES: CC(=O)C(/N=N/c1ccccc1C(F)(F)F)C(=O)Nc1ccc2[nH]c(=O)[nH]c2c1 ; O=C(Nc1ccccc1)C1=Cc2ccccc2/C(=N/Nc2cc(Cl)ccc2Cl)C1=O ; CC(=O)C(/N=N/c1ccccc1C(=O)O)C(=O)Nc1ccc2[nH]c(=O)[nH]c2c1]
or a combination thereof.

3. The pigment composite particle as claimed in claim 1, wherein the organic pigment core has a diameter of 200 nm to 5 μm.

4. The pigment composite particle as claimed in claim 1, wherein the polyelectrolyte shell is negatively charged.

5. The pigment composite particle as claimed in claim 4, wherein the polyelectrolyte comprises polystyrene sulfonate, poly(acrylic acid), or a combination thereof.

6. The pigment composite particle as claimed in claim 1, wherein the polyelectrolyte shell is positively charged.

7. The pigment composite particle as claimed in claim 6, wherein the polyelectrolyte comprises poly(diallyldimethyl ammonium chloride), p-aminohippurate, polyacrylamide, or a combination thereof.

8. The pigment composite particle as claimed in claim 1, wherein the polyelectrolyte shell has a weight average molecular weight of 70,000 to 350,000.

9. The pigment composite particle as claimed in claim 1, wherein the organic pigment core and the polyelectrolyte shell have a weight ratio of 1:0.25 to 1:1.

10. The pigment composite particle as claimed in claim 1, wherein the oxide shell is formed from tetraalkyl orthosilicate, tetraalkyl orthotitanate, or a combination thereof.

11. The pigment composite particle as claimed in claim 8, wherein the organic pigment core and the tetraalkyl orthosilicate, tetraalkyl orthotitanate, or the combination thereof have a weight ratio of 1:0.7 to 1:3.

12. The pigment composite particle as claimed in claim 1, wherein the pigment composite particle has a diameter of 300 nm to 10 μm.
